(19) United States
(12) Patent Application Publication
(10) Pub. No.: US 2024/0022269 A1
(43) Pub. Date: Jan. 18, 2024

(54) WIRELESS RELAY SYSTEM, WIRELESS RELAY METHOD, AND WIRELESS COMMUNICATION DEVICE

(71) Applicant: NIPPON TELEGRAPH AND TELEPHONE CORPORATION, Tokyo (JP)

(72) Inventors: Hiroyuki FURUYA, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/036,431

(22) PCT Filed: Nov. 25, 2020
(86) PCT No.: PCT/JP2020/043825

§ 371 Date: May 11, 2023

(51) Int. Cl. H04B 1/00; H04B 7/155

(52) U.S. Cl. CPC H04B 1/0096; H04B 7/155

(57) ABSTRACT

A signal transmitted by a transmission device is converted into a signal of another frequency having a bandwidth equal to or greater than that of the transmission device, the signal obtained by converting the frequency is divided into signals of a plurality of frequency bands, signals of one or more frequency bands having high priorities are specified among the divided signals of the plurality of frequency bands, the signals are duplicated as signals of other frequency bands, the divided signals of the plurality of frequency bands and the duplicated signals of the other frequency bands are wirelessly transmitted, the transmitted signals are wirelessly received, signal combination is performed to reproduce the converted signals of the other frequencies using the received signals, and the combined signals are converted into a signal with a predetermined frequency.

### TECHNICAL FIELD

The present invention relates to a radio relay system, a radio relay method, and a radio communication device.

### BACKGROUND ART

For example, in radio communication including a backhaul and a fronthaul such as Long Term Evolution (LTE), there is a configuration in which a base station is separated into a modulation unit (a base band unit (BBU)) and a radio unit (a remote radio head (RRH)) (a configuration of an overhanging antenna). With the configuration of the overhanging antenna, it is possible to improve the degree of freedom of installation of the antenna and relay signals.

For example, the BBU outputs a common public radio interface (CPRI) signal obtained by digitizing a radio wave waveform to the RRH via an optical fiber. The RRH emits a signal as radio waves via a connected antenna based on the input CPRI signal.

At this time, since the CPRI signal is not a signal which is originally emitted by the base station (radio waves used by the mobile phone terminal), the CPRI signal is generated through signal conversion.

As a technique for relaying a radio signal by performing frequency conversion, a technique in which a transmission device band-divides and transmits a modulated signal and a reception device combines the received signal with an original modulated signal is known (see, for example, Patent Literature 1.).

### CITATION LIST

### Patent Literature

Patent Literature 1: WO 2010/113499 A

### SUMMARY OF INVENTION

### Technical Problem

However, when protocol conversion is performed as in a CPRI signal, a signal to be relayed is delayed through a conversion process. Further, when signal conversion involves conversion of a radio frequency, another frequency band is required, and frequency resources cannot be used efficiently in some cases. Even when a radio signal involved in priority control is relayed, delay may occur due to protocol conversion or buffering.

An objective of the present invention is to provide a radio relay system, a radio relay method, and a radio communication device capable of relaying a signal while achieving both a reduction in delay due to frequency conversion and a reduction in delay by priority control while efficiently using a radio frequency.

### Solution to Problem

A radio relay system according to an aspect of the present invention is a radio relay system in which a first communication device connected to a transmission device and a second communication device connected to a reception device perform wireless relay between the transmission device and the reception device. The first communication device includes a first frequency conversion unit that converts a signal transmitted by the transmission device into a signal with another frequency having a bandwidth equal to or greater than a bandwidth of the transmission device, a frequency division unit that divides the signal frequency-converted by the first frequency conversion unit into signals of a plurality of frequency bands, a duplication unit that specifies signals of one or more frequency bands having high priorities among the signals of the plurality of frequency bands divided by the frequency division unit and duplicates the signals as signals of other frequency bands, and a radio transmission unit that wirelessly transmits the signals of the plurality of frequency bands divided by the frequency division unit and the signals of the other frequency bands duplicated by the duplication unit. The second communication device includes a radio reception unit that wirelessly receives the signals transmitted by the radio transmission unit, a combination unit that performs signal combination using the signals received by the radio reception unit to reproduce the signals of the other frequencies converted by the first frequency conversion unit, and a second frequency conversion unit that converts the signals combined by the combination unit into a signal with a predetermined frequency.

A radio relay method according to another aspect of the present invention is a radio relay method in which a first communication device connected to a transmission device and a second communication device connected to a reception device perform wireless relay between the transmission device and the reception device. The method includes: a first frequency conversion step of converting a signal transmitted by the transmission device into a signal of another frequency having a bandwidth equal to or greater than a bandwidth of the transmission device; a frequency division step of dividing the signal frequency-converted by the first frequency conversion unit into signals of a plurality of frequency bands; a duplication step of specifying signals of one or more frequency bands having high priorities among signals of the plurality of divided frequency bands and duplicating the signals as signals of other frequency bands;
a transmission step of wirelessly transmitting the signals of the plurality of divided frequency bands and the duplicated signals of the other frequency bands; a reception step of wirelessly receiving the transmitted signals;
a combination step of performing signal combination using the received signals to reproduce the signals of the other frequencies converted in the first frequency conversion step; and a second frequency conversion step of converting the combined signals into a signal of a predetermined frequency.

A radio communication device according to still another aspect of the present invention is a radio communication device that is connected to a transmission device and performs wireless relay between the transmission device and a reception device together with another radio communication device connected to the reception device. The radio communication device includes: a first frequency conversion unit configured to convert a signal transmitted by the transmission device into a signal with another frequency having a bandwidth equal to or greater than a bandwidth of the transmission device; a frequency division unit configured to divide the signal frequency-converted by the first frequency conversion unit into signals of a plurality of frequency bands, a duplication unit configured to specify signals of one or more frequency bands having high priorities among the signals of the plurality of frequency bands divided by the frequency division unit and duplicate the signals as signals of other frequency bands; and a radio transmission unit configured to wirelessly transmit the signals of the plurality of frequency bands divided by the frequency division unit and the signals of the other frequency bands duplicated by the duplication unit.

### Advantageous Effects of Invention

According to the present invention, it is possible to relay a signal while achieving both a reduction in delay due to frequency conversion and a reduction in delay by priority control while efficiently using a radio frequency.

### BRIEF DESCRIPTION OF DRAWINGS

FIG. 1 is a diagram illustrating a configuration example of a radio relay system according to an embodiment.

FIG. 2(a) is a diagram illustrating data of a plurality of users for enabling the base station device to perform frequency division multiple access. FIG. 2(b) is a diagram illustrating a state in which a plurality of pieces of user data are allocated for each frequency band through orthogonal frequency division multiple access.

FIG. 3 is a diagram illustrating a configuration example of a first communication device and its periphery.

FIG. 4(a) is a diagram illustrating a frequency band A before frequency conversion. FIG. 4(b) is a diagram illustrating a frequency band A′ after frequency conversion. FIG. 4(c) is a diagram illustrating a plurality of divided frequency bands. FIG. 4(d) is a diagram illustrating a plurality of divided frequency bands including duplicated frequency bands. FIG. 4(e) is a diagram illustrating a plurality of divided frequency bands including the transmission control information and the duplicated frequency bands.

FIG. 5 is a diagram illustrating a configuration example of a second communication device and its periphery.

FIG. 6(a) is a diagram illustrating a configuration example of a base station including an overhanging antenna.

FIG. 6(b) is a diagram illustrating a configuration example of a base station including an overhanging antenna using fixed microwave radio.

### DESCRIPTION OF EMBODIMENTS

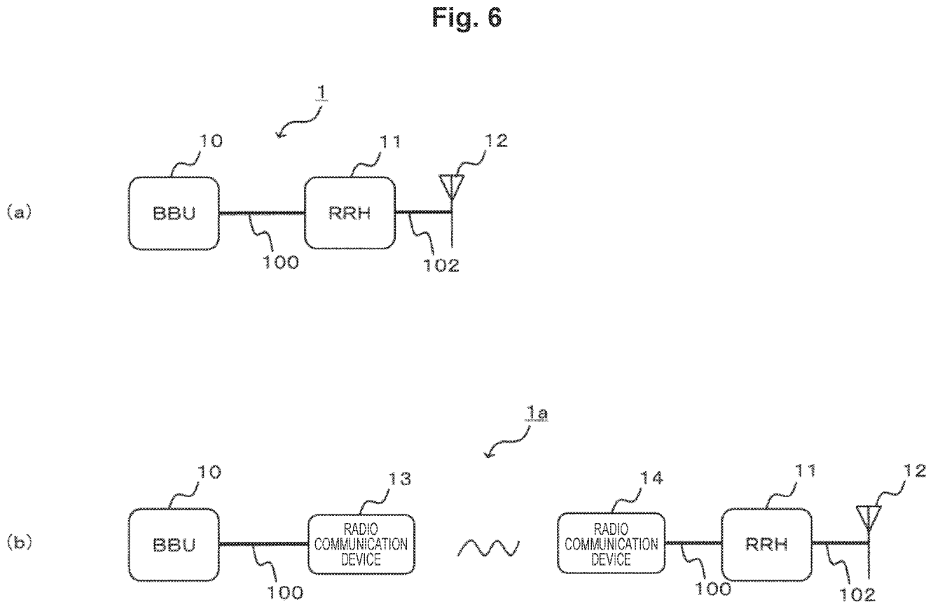

First, the background of the present invention will be described. FIG. 6 is a diagram illustrating a configuration example of a base station in a radio communication system such as LTE. FIG. 6(a) is a diagram illustrating a configuration example of the base station 1 having an overhanging antenna. FIG. 6(b) is a diagram illustrating a configuration example of a base station 1a including an overhanging antenna using fixed microwave radio.

As illustrated in FIG. 6(a), the base station 1 includes a BBU 10, an RRH 11, and an antenna 12 and relays a signal in a radio communication system such as LTE. The BBU 10 is connected to the RRH 11 through an optical fiber 100 and transmits a signal to the RRH 11 using a communication protocol such as CPRI. The RRH 11 is connected to the antenna 12 through, for example, a coaxial cable 102.

In this way, the base station 1 is configured such that the BBU 10 and the RRH 11 connected through the optical fiber 100 are located apart from each other, and thus a configuration of an overhanging antenna is formed. However, since the BBU 10 converts a transmission signal into a CPRI signal and transmits the CPRI signal, conversion delay is caused in the transmission signal.

As illustrated in FIG. 6(b), the base station 1a includes a BBU 10, an RRH 11, an antenna 12, a radio communication device 13, and a radio communication device 14. The BBU 10 is connected to the radio communication device 13 via the optical fiber 100. The radio communication device 14 is connected to the RRH 11 via the optical fiber 100. The RRH 11 is connected to the antenna 12 via a coaxial cable 102.

Further, the BBU 10 converts the transmission signal into a CPRI signal and transmits the CPRI signal to the radio communication device 13. The radio communication device 13 converts the received CPRI signal into microwaves radio communication protocol and emits the microwave to the radio communication device 14. At this time, the radio communication device 13 converts the CPRI signal into a microwave having a continuous frequency bandwidth equal to or greater than the frequency band of the CPRI signal transmitted from the BBU 10.

The radio communication device 14 converts the microwaves received from the radio communication device 13 into a CPRI signal and transmits the CPRI signal to the RRH 11. The RRH 11 relays a signal to a mobile terminal (UE) (not illustrated) by emitting the transmission signal from the antenna 12 via the coaxial cable 102.

That is, since the communication between the radio communication device 13 and the radio communication device 14 is unwired, the base station 1a is configured with higher installation flexibility of the BBU 10, the RRH 11, and the antenna 12 than the base station 1. The base station 1a can relay a signal even when it is difficult to lay the optical fiber 100 to directly connect the BBU 10 and the RRH 11.

However, in order to transmit a signal from the BBU 10 to the antenna 12, the base station 1a repeats conversion of the signal a plurality of times, and causes a larger conversion delay in the transmission signal than the base station 1.

In 5G (5th generation mobile communication system) or the like, delay is an important factor in quality evaluation, and reducing the delay is an issue. In the radio relay system, it is desirable that the BBU 10 and the RRH 11 be integrated to directly relay radio waves to a mobile terminal in order to reduce the delay.

When a signal is relayed, a technique such as radio on fiber, radio over fiber (Rof) in which a radio high-frequency signal is carried on an optical fiber and transmitted, and radio waves are delivered to a place that the radio waves do not directly reach may be used.

When radio is used for signal relay, it is conceivable to use frequency conversion like the RoF. In this case, a continuous relay radio frequency band equal to or greater than a frequency bandwidth used by the base station is required, but it may be difficult to guarantee frequency resources. When a specific signal is preferentially relayed with high quality and radio is used to relay a signal, it is, in the related art, it is difficult to achieve redundancy for reducing an influence of radio noise.

Therefore, the present application discloses a radio relay system, a radio relay method, and a radio communication device capable of relaying a signal while achieving both a reduction in delay through frequency conversion and a reduction in delay through priority control while efficiently using a radio frequency.

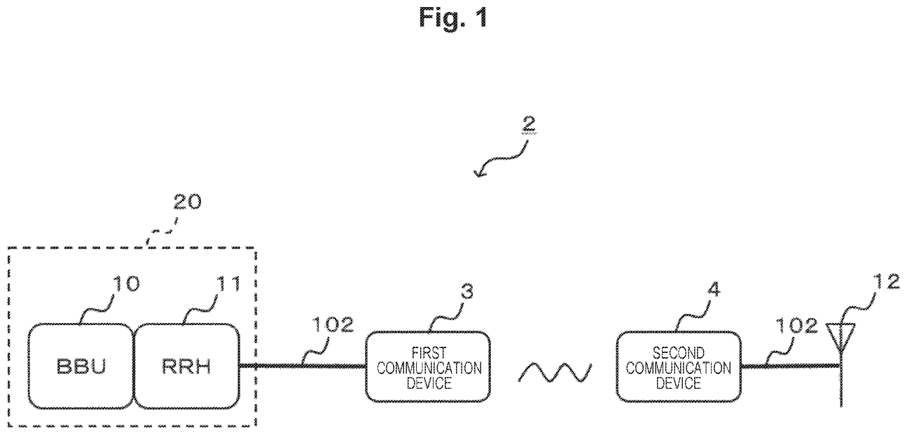

FIG. 1 is a diagram illustrating a configuration example of a radio relay system 2 according to an embodiment. As illustrated in FIG. 1, the radio relay system 2 includes a base station device 20, a first communication device (a radio communication device) 3, a second communication device (a radio communication device) 4, and an antenna 12.

The base station device 20 has a configuration in which the BBU 10 and the RRH 11 are integrated and is connected to the first communication device 3 via a coaxial cable 102. In addition, the second communication device 4 is connected to the antenna 12 via the coaxial cable 102.

Further, the radio relay system 2 relays a signal transmitted by the base station device 20 to a mobile terminal (UE) (not illustrated) by causing the signal to be emitted via the first communication device 3, the second communication device 4, and the antenna 12.

Hereinafter, the same reference numerals are given to configurations substantially the same as the above-described configurations. In the following description, a case where the radio relay system 2 relays a downlink signal will be described as an example, but the radio relay system 2 has a function of relaying an uplink signal similarly.

Therefore, in order to describe the radio relay system 2 when the antenna 12 receives and emits a signal transmitted by the base station device 20 to relay the signal to a mobile terminal (UE) (not illustrated), the base station device 20 is referred to as a transmission device, and the antenna 12 is referred to as a reception device in some cases.

Here, the BBU 10 outputs a transmission signal to the RRH 11 without converting the transmission signal into a CPRI signal. The RRH 11 outputs a signal input from the BBU 10 to the first communication device 3 via the coaxial cable 102.

The first communication device 3 converts a signal input from the RRH 11 into, for example, a microwave radio communication protocol, and emits microwaves having a transmission frequency to the second communication device 4.

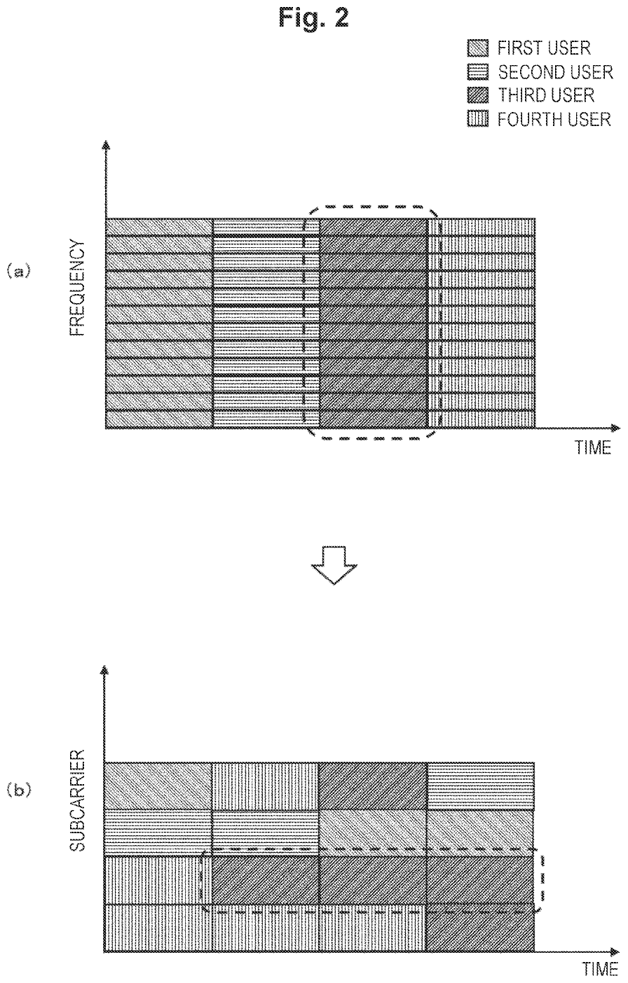

For example, as illustrated in FIG. 2(a), it is assumed that the base station device 20 retains data of a plurality of users that enables frequency division multiple access (FDMA) in an internal transmission buffer (not illustrated). At this time, for example, it is assumed that data of a third user is data with high priority (importance).

The first communication device 3 allocates and transmits, for example, a plurality of pieces of user data for each frequency band by orthogonal frequency division multiple access (OFDMA), as illustrated in FIG. 2(b), along with information indicating that the data of the third user is data with high priority (importance).

The second communication device 4 outputs microwaves received from the first communication device 3 to the antenna 12 via the coaxial cable 102 without converting the microwaves into a CPRI signal. The antenna 12 relays a signal to a mobile terminal (UE) (not illustrated) by emitting a signal input from the second communication device 4.

In this way, the radio relay system 2 does not convert the signal to be relayed into the CPRI signal or re-convert the CPRI signal into the original signal. Therefore, even when a part of the relay section is unwired, the delay due to the signal conversion is reduced as compared with the base station 1a (see FIG. 6).

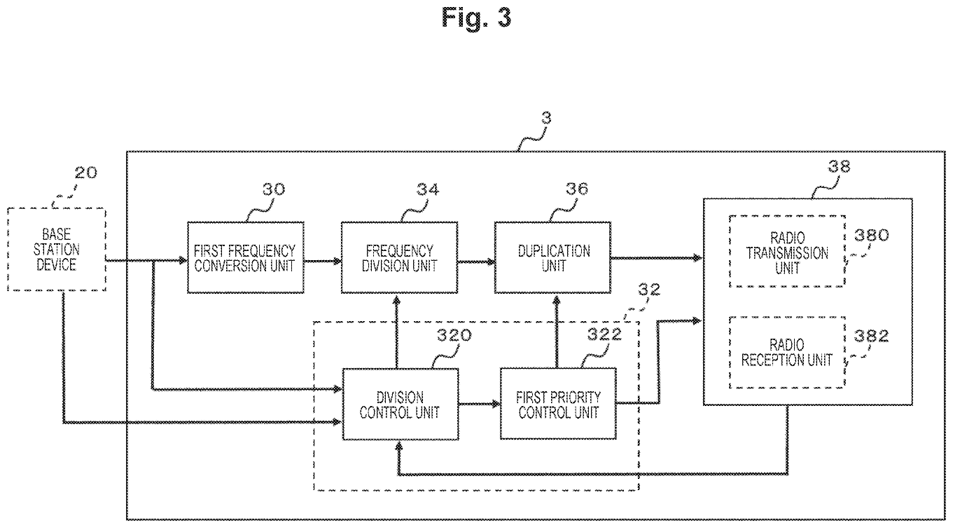

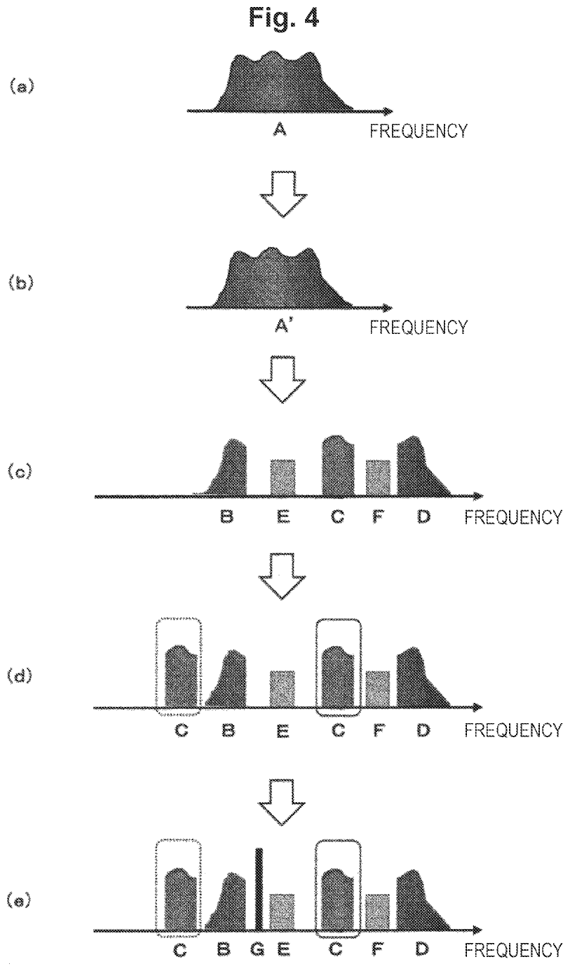

Next, a more specific configuration of the first communication device 3 and processing performed by the first communication device 3 will be described with reference to FIGS. 3 and 4. FIG. 3 is a diagram illustrating a configuration example of the first communication device 3 and its periphery. FIG. 4 is a diagram schematically illustrating a frequency band of a signal processed by the first communication device 3. FIG. 4(a) is a diagram illustrating a frequency band A before frequency conversion. FIG. 4(b) is a diagram illustrating a frequency band A′ after frequency conversion. FIG. 4(c) is a diagram illustrating a plurality of divided frequency bands. FIG. 4(d) is a diagram illustrating a plurality of divided frequency bands including duplicated frequency bands. FIG. 4(e) is a diagram illustrating a plurality of divided frequency bands including the transmission control information and the duplicated frequency bands.

As illustrated in FIG. 3, the first communication device 3 includes a first frequency conversion unit 30, a control unit 32, a frequency division unit 34, a duplication unit 36, and a radio communication unit 38.

The first frequency conversion unit 30 converts a signal transmitted by the base station device 20 (a transmission device) into a signal of another frequency having a bandwidth equal to or greater than that of the base station device, and outputs the signal to the frequency division unit 34.

For example, the first frequency conversion unit 30 converts a signal (a spectrum) of the frequency band A illustrated in FIG. 4(a) into a signal (a spectrum) of the frequency band A′ of a microwave illustrated in FIG. 4(b), and outputs the converted signal.

The control unit 32 includes a division control unit 320 and a first priority control unit 322 and controls the frequency division unit 34 and the duplication unit 36 based on signals input from the base station device 20 and the radio communication unit 38.

The division control unit 320 acquires information including, for example, Ch usage information output from the base station device 20, priority information of a packet, and free space information of a radio communication path. The division control unit 320 acquires an environmental condition of the radio communication path, a usage status of the radio communication path by another system, and the like based on the information received by the radio communication unit 38. Then, based on the acquired information, the division control unit 320 determines a division block width and the number of frequencies to be subjected to frequency division by the frequency division unit 34 and an allocation position on a frequency axis, and outputs control information for controlling the number of band divisions, a band block width, and the like to the frequency division unit 34. The division control unit 320 also outputs the acquired information and control information for the frequency division unit 34 to the first priority control unit 322.

The first priority control unit 322 controls the duplication unit 36 such that one or more band blocks including priority packets within a predetermined frequency band are duplicated by the duplication unit 36 based on the information input from the division control unit 320. The first priority control unit 322 outputs the control information output from the division control unit 320 to the frequency division unit 34 to the radio communication unit 38 as transmission control information.

For example, the first priority control unit 322 performs control such that the radio communication unit 38 transmits the frequency band information indicating the frequency band of each of the signals of the plurality of frequency bands divided by the frequency division unit 34 and the duplicated frequency band information indicating the frequency band of the signal of another frequency band duplicated by the duplication unit 36 in a band different from the other signals in the band of the signal converted by the first frequency conversion unit 30.

Based on the control of the division control unit 320, the frequency division unit 34 divides the signal of which a frequency is converted by the first frequency conversion unit 30 into signals of a plurality of frequency bands and outputs the signals to the duplication unit 36.

For example, the frequency division unit 34 divides the signal of the microwave frequency band A′ illustrated in FIG. 4(b) into signals of a plurality of frequency bands B, C, and D illustrated in FIG. 4(c). At this time, when there is a frequency band E of substantially the same frequency band used by another system or a frequency band F, the frequency division unit 34 allocates the plurality of frequency bands B, C, and D to a frequency band avoiding the frequency band E or the frequency band F based on the control of the division control unit 320.

The duplication unit 36 specifies signals of one or more frequency bands (the divided blocks) having high priorities among the signals of the plurality of frequency bands divided by the frequency division unit 34 under the control of the first priority control unit 322, and duplicates the divided blocks as signals of other frequency bands. Then, the duplication unit 36 outputs the signals of the plurality of frequency bands input from the frequency division unit 34 and the duplicated divided blocks to the radio communication unit 38.

For example, as illustrated in FIG. 4(d), the duplication unit 36 duplicates a band block including a priority packet allocated to the frequency band C to a frequency band lower than the frequency band B of substantially the same frequency band.

The radio communication unit 38 includes a radio transmission unit 380 and a radio reception unit 382, and transmits and receives radio waves to and from the second communication device 4 via an antenna (not illustrated).

Under the control of the first priority control unit 322, the radio transmission unit 380 adds the transmission control information input from the first priority control unit 322 to the signals of the plurality of frequency bands input from the duplication unit 36 and the duplicated signals of the divided blocks and allocates the signals to predetermined bands to wirelessly transmit the signals.

For example, as illustrated in FIG. 4(e), the radio transmission unit 380 transmits the transmission control information in the frequency band G in the unused frequency band between the frequency bands B and E.

The radio reception unit 382 acquires, for example, an environmental condition of the radio communication path, a usage status of the radio communication path by another system, and the like from the wirelessly received signal, and outputs the acquired signal to the division control unit 320.

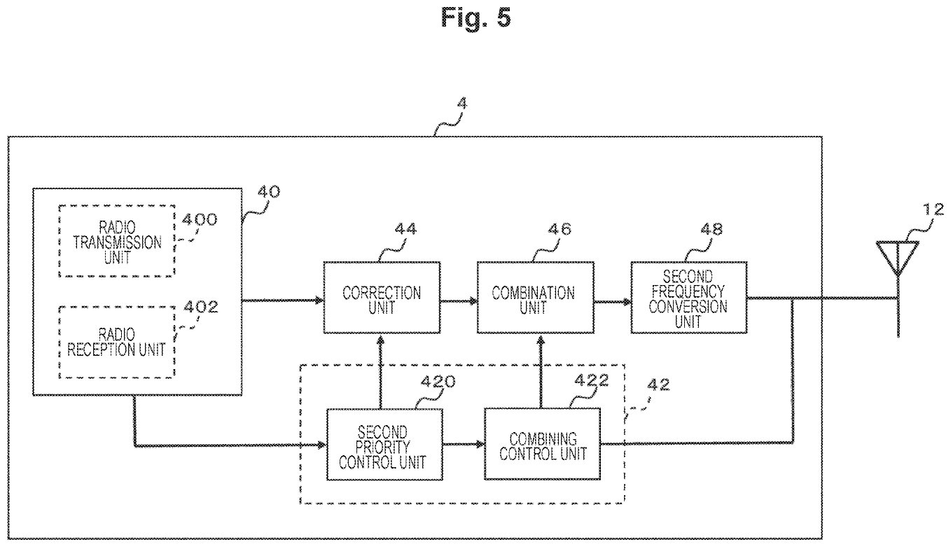

Next, a more specific configuration of the second communication device 4 will be described. FIG. 5 is a diagram illustrating a configuration example of the second communication device 4 and its periphery. As illustrated in FIG. 5, the second communication device 4 includes a radio communication unit 40, a control unit 42, a correction unit 44, a combination unit 46, and a second frequency conversion unit 48.

The radio communication unit 40 includes a radio transmission unit 400 and a radio reception unit 402, and transmits and receives radio waves to and from the first communication device 3 via an antenna (not illustrated). The radio transmission unit 400 emits a radio wave to the first communication device 3. The radio reception unit 382 receives the radio wave transmitted by the first communication device 3 and outputs the received signal to the control unit 42 and the correction unit 44.

The control unit 42 includes a second priority control unit 420 and a combination control unit 422, and controls the correction unit 44 and the combination unit 46 based on a signal input from the radio communication unit 40.

The second priority control unit 420 acquires the above-described transmission control information and the like from the signal received by the radio reception unit 402, and controls the correction unit 44 and the combination control unit 422 based on the frequency band information of the plurality of divided frequency bands and the duplication frequency band information indicating the frequency band of the duplicated signal.

The combination control unit 422 controls the combination unit 46 based on the information input from the second priority control unit 420. When the frequency band duplicated in the reception signal is included, the combination control unit 422 may compare the frequency band before the duplication with the frequency band after the duplication, and perform control such that the combination unit 46 performs combination using a signal with a higher reception level.

The correction unit 44 acquires the frequency band information of the plurality of frequency bands divided from the second priority control unit 420 and the duplicated frequency band information indicating the frequency band of the duplicated signal, and corrects one or more frequency bands (the divided blocks) having high priorities.

For example, the correction unit 44 compares the pre-replication frequency band having a high priority with the post-replication frequency band having a high priority, and corrects the signal of the frequency band having a higher priority to a correct value.

Then, the correction unit 44 outputs the signals of the plurality of divided frequency bands and the corrected signals of one or more frequency bands having high priorities to the combination unit 46.

Under the control of the combination control unit 422, the combination unit 46 combines the signals of the plurality of frequency bands input from the correction unit 44 and the corrected signal of the frequency band based on the frequency band information and the duplicated frequency band information described above, and outputs the combined signal to the second frequency conversion unit 48. That is, the combination unit 46 uses the signal received by the radio reception unit 402 to perform signal combination to reproduce the signal of another frequency converted by the above-described first frequency conversion unit 30 (FIG. 3).

The second frequency conversion unit 48 converts the signal combined by the combination unit 46 into a signal with a predetermined frequency (for example, a signal with an original frequency) and outputs the signal to the antenna 12.

As described above, the radio relay system 2 specifies signals of one or more frequency bands having high priorities among the signals of the plurality of divided frequency bands, duplicates the signals as signals of other frequency bands, and wirelessly transmits the signals along with the signals of the plurality of divided frequency bands. Therefore, it is possible to relay the signal while achieving both a reduction in the delay by the frequency conversion and a reduction in the delay by the priority control while efficiently using the radio frequency. For example, the radio relay system 2 can improve quality of data communication by duplicating signals in frequency bands including data of a user with high priority (important).

The radio relay system 2 allocates a frequency domain for each communication user or each traffic type by focusing on a signal (FDMA) to be relayed. Therefore, it is possible to determine band division and allocation according to a user or a traffic.

Even when radio relay is performed in a frequency band in which a continuous frequency band cannot be guaranteed, the radio relay system 2 can perform a reduction in delay and priority control of a radio relay section. At this time, the second communication device 4 may receive the allocation information of the frequency band of FDMA. That is, the radio relay system 2 can perform the priority control without having an effect on a user traffic.

Some or all of the functions of the first communication device 3 or the second communication device 4 may be configured by hardware such as a programmable logic device (PLD) or a field programmable gate array (FPGA) or may be configured as a program executed by a processor such as a CPU.

### REFERENCE SIGNS LIST

1 Base station
2 Radio relay system
3 First communication device
4 Second communication device
10 BBU
11 RRH
12 Antenna
20 Base station device
30 First frequency conversion unit
32 Control unit
34 Frequency division unit
36 Duplication unit
38 Radio communication unit
40 Radio communication unit
42 Control unit
44 Correction unit
46 Combination unit
48 Second frequency conversion unit
100 Optical fiber
102 Coaxial cable
320 Division control unit
322 First priority control unit
380 Radio transmission unit
382 Radio reception unit
400 Radio transmission unit
402 Radio reception unit
420 Second priority control unit
422 Combination control unit

1. A radio relay system in which a first communication device connected to a transmission device and a second communication device connected to a reception device perform wireless relay between the transmission device and the reception device,
wherein the first communication device includes
a first frequency conversion unit that converts a signal transmitted by the transmission device into a signal with another frequency having a bandwidth equal to or greater than a bandwidth of the transmission device,
a frequency division unit that divides the signal frequency-converted by the first frequency conversion unit into signals of a plurality of frequency bands,
a duplication unit that specifies signals of one or more frequency bands having high priorities among the signals of the plurality of frequency bands divided by the frequency division unit and duplicates the signals as signals of other frequency bands, and
a radio transmission unit that wirelessly transmits the signals of the plurality of frequency bands divided by the frequency division unit and the signals of the other frequency bands duplicated by the duplication unit,
and
wherein the second communication device includes
a radio reception unit that wirelessly receives the signals transmitted by the radio transmission unit,
a combination unit that performs signal combination using the signals received by the radio reception unit to reproduce the signals of the other frequencies converted by the first frequency conversion unit, and
a second frequency conversion unit that converts the signals combined by the combination unit into a signal with a predetermined frequency.

2. The radio relay system according to claim 1,
wherein the first communication device further includes a control unit that controls the radio transmission unit such that frequency band information indicating a frequency band of each of the signals with the plurality of frequency bands divided by the frequency division unit and duplicated frequency band information indicating the frequency bands of the signals of the other frequency bands duplicated by the duplication unit are transmitted in a different band from the other signals in the band of the signal converted by the first frequency conversion unit, and
wherein the combination unit performs the signal combination based on the frequency band information and the duplication frequency band information.

3. A radio relay method in which a first communication device connected to a transmission device and a second communication device connected to a reception device perform wireless relay between the transmission device and the reception device, the method comprising:
a first frequency conversion step of converting a signal transmitted by the transmission device into a signal of another frequency having a bandwidth equal to or greater than a bandwidth of the transmission device;
a frequency division step of dividing the signal frequency-converted by the first frequency conversion unit into signals of a plurality of frequency bands;
a duplication step of specifying signals of one or more frequency bands having high priorities among signals of the plurality of divided frequency bands and duplicating the signals as signals of other frequency bands;
a transmission step of wirelessly transmitting the signals of the plurality of divided frequency bands and the duplicated signals of the other frequency bands;
a reception step of wirelessly receiving the transmitted signals;
a combination step of performing signal combination using the received signals to reproduce the signals of the other frequencies converted in the first frequency conversion step; and
a second frequency conversion step of converting the combined signals into a signal of a predetermined frequency.

4. The radio relay method according to claim 3, further comprising:
a control step of performing control such that frequency band information indicating a frequency band of each of the signals with the plurality of divided frequency bands and duplicated frequency band information indicating the frequency bands of the signals of the other duplicated frequency bands are transmitted in a different band from the other signals in the band of the signal converted in the first frequency conversion step,
wherein, in the combination step, the signal combination is performed based on the frequency band information and the duplication frequency band information.

5. A radio communication device that is connected to a transmission device and perform wireless relay between the transmission device and a reception device together with another radio communication device connected to the reception device, the radio communication device comprising:
a first frequency conversion unit configured to convert a signal transmitted by the transmission device into a signal with another frequency having a bandwidth equal to or greater than a bandwidth of the transmission device;
a frequency division unit configured to divide the signal frequency-converted by the first frequency conversion unit into signals of a plurality of frequency bands,
a duplication unit configured to specify signals of one or more frequency bands having high priorities among the signals of the plurality of frequency bands divided by the frequency division unit and duplicate the signals as signals of other frequency bands; and
a radio transmission unit configured to wirelessly transmit the signals of the plurality of frequency bands divided by the frequency division unit and the signals of the other frequency bands duplicated by the duplication unit.

6. The radio communication device according to claim 5, further comprising:
a control unit that controls the radio transmission unit such that frequency band information indicating a frequency band of each of the signals with the plurality of frequency bands divided by the frequency division unit and duplicated frequency band information indicating the frequency bands of the signals of the other frequency bands duplicated by the duplication unit are transmitted in a different band from the other signals in the band of the signal converted by the first frequency conversion unit.
